(19) United States
(12) Patent Application Publication
(10) Pub. No.: US 2011/0128212 A1
(43) Pub. Date: Jun. 2, 2011

(54) DISPLAY DEVICE HAVING AN INTEGRATED LIGHT SOURCE AND ACCELEROMETER

(75) Inventors: Manish Kothari, Cupertino, CA (US); Evgeni Gousev, Saratoga, CA (US); Russel Allyn Martin, Menlo Park, CA (US)

(73) Assignee: QUALCOMM MEMS Technologies, Inc., San Diego, CA (US)

(21) Appl. No.: 12/629,456

(22) Filed: Dec. 2, 2009

(51) Int. Cl. G09G 3/32; G09G 3/20; G09G 3/36; G01P 15/00

(52) U.S. Cl. 345/82; 345/55; 345/87; 702/141

(57) ABSTRACT

A display device having an illumination system with integrated accelerometer is disclosed in which a portion of the illumination system is used as the proof mass for the accelerometer. In one embodiment, the display device includes a plurality of display elements, one or more light sources, one or more light redirectors configured to redirect at least a portion of the light generated by the light sources to at least a portion of the plurality of display elements, one or more light detectors each configured to determine a light intensity, and a processor configured to determine one or more accelerations based on the determined light intensity.

### BACKGROUND

1. Field

The field of the invention relates to displays and accelerometers.

2. Description of the Related Technology

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively transmits, absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

One aspect is a display device comprising a plurality of display elements, an illumination system comprising at least a light source and configured to direct light emitted by the light source to the display elements, a detector configured to detect movement of at least a portion of the illumination system relative to the detector, and a processor configured to determine one or more accelerations based, at least in part, on the detected movement.

Another aspect is a method of determining an acceleration, the method comprising detecting, using a detector, a movement of at least a portion of a illumination system of a display device comprising a plurality of display elements and the illumination system comprising at least a light source and configured to direct light emitted by the light source to the display elements, and determining, using a processor, an acceleration based, at least in part, on the detected movement.

Another aspect is a system for determining an acceleration, the system comprising modulation means for modulating light, illumination means comprising at least a light generation means and for directing light emitted by a light generation means to the display elements the modulation means, detection means for detecting movement of at least a portion of the illumination means relative to the detection means, and processing means for determining one or more accelerations based, at least in part, on the detected movement.

Yet another aspect is a display device comprising a plurality of display elements, one or more light sources, one or more light redirectors configured to redirect at least a portion of the light generated by the light sources to at least a portion of the plurality of display elements, one or more light detectors each configured to determine a light intensity, and a processor configured to determine one or more accelerations based on the determined light intensity.

Yet another aspect is a method of determining an acceleration in a display device comprising a plurality of display elements and an illumination system configured to illuminate at least a portion of the display elements, the method comprising using at least a portion of the illumination system as the proof mass of an accelerometer.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7 is a side view of a display including a front light.

FIG. 8 is a side view of a display including a back light.

FIG. 9 is a front view of one embodiment of a display including an illumination system.

FIG. 10 is a front view of another embodiment of a display including an illumination system.

FIG. 11 is a diagram of an embodiment of a turning bar.

FIG. 12 is a front view of a display having an integrated illumination system and accelerometer.

FIG. 13 is a flowchart illustrating a method of determining an acceleration.

### DETAILED DESCRIPTION OF THE PREFERRED EMBODIMENT

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

In one embodiment, an array of interferometric modulators is used as the screen of an electronic device to display information. Interferometric modulators are specular display elements in that they do not produce their own light, but rather reflect, transmit, or absorb incident light. Thus, in some embodiments, the electronic device includes an illumination system to illuminate the array in dim and/or dark conditions. The illumination system can include a source of light and a one or more light redirectors, including mirrors and lenses, which redirect the light from the source to the array. The electronic device may also benefit from an accelerometer. For example, an accelerometer can be used as an input device to allow a user to control the electronic device by moving it.

Generally, an accelerometer functions to determine acceleration by detecting the motion of a proof mass. In one embodiment, at least a portion of the illumination system is used as the proof mass. Thus, detection of the motion of at least a portion of the illumination system, such as the light source or a light redirector, can be used to determine an acceleration of the electronic device. Because a separate proof mass is not required, the footprint of the device can be reduced. Further, the cost of the device can also be reduced.

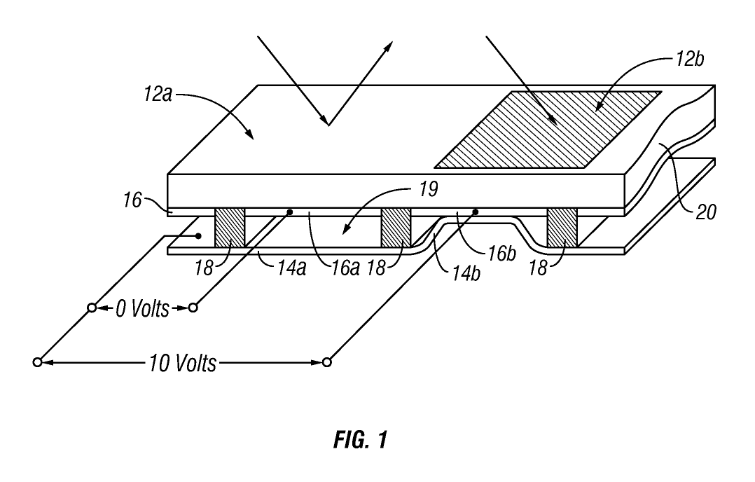

One interferometric modulator display embodiment comprising an interferometric MEMS display element is illustrated in FIG. 1. In these devices, the pixels are in either a bright or dark state. In the bright (“on” or “open”) state, the display element reflects (or transmit) a large portion of incident visible light to a user. When in the dark (“off” or “closed”) state, the display element reflects (or transmit) little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical cavity with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise of several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. In some embodiments, the layers are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the cavity 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

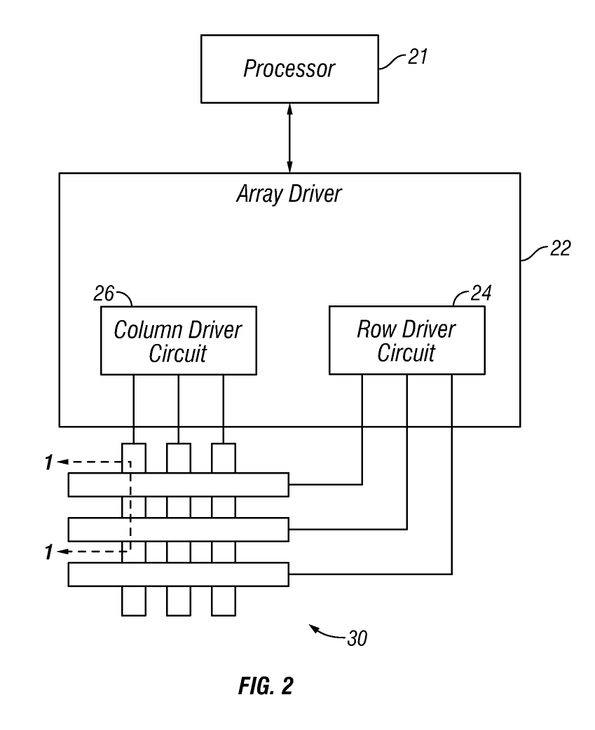

FIGS. 2 through 5 illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

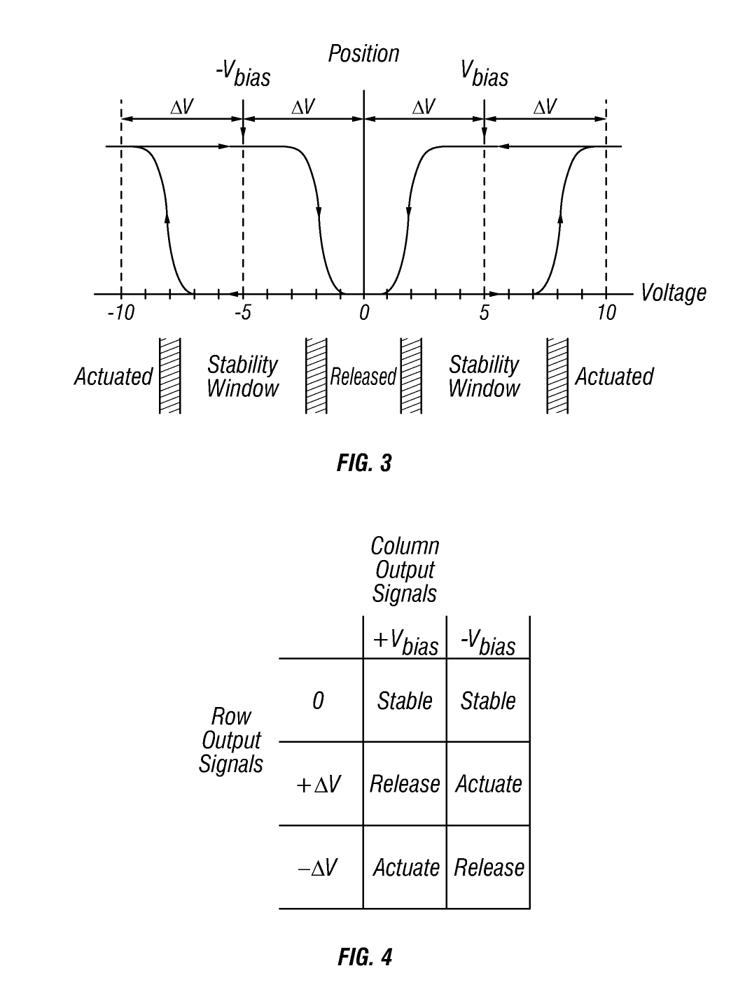

In one embodiment, the processor 21 is also configured to communicate with an array driver 22. In one embodiment, the array driver 22 includes a row driver circuit 24 and a column driver circuit 26 that provide signals to a panel or display array (display) 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

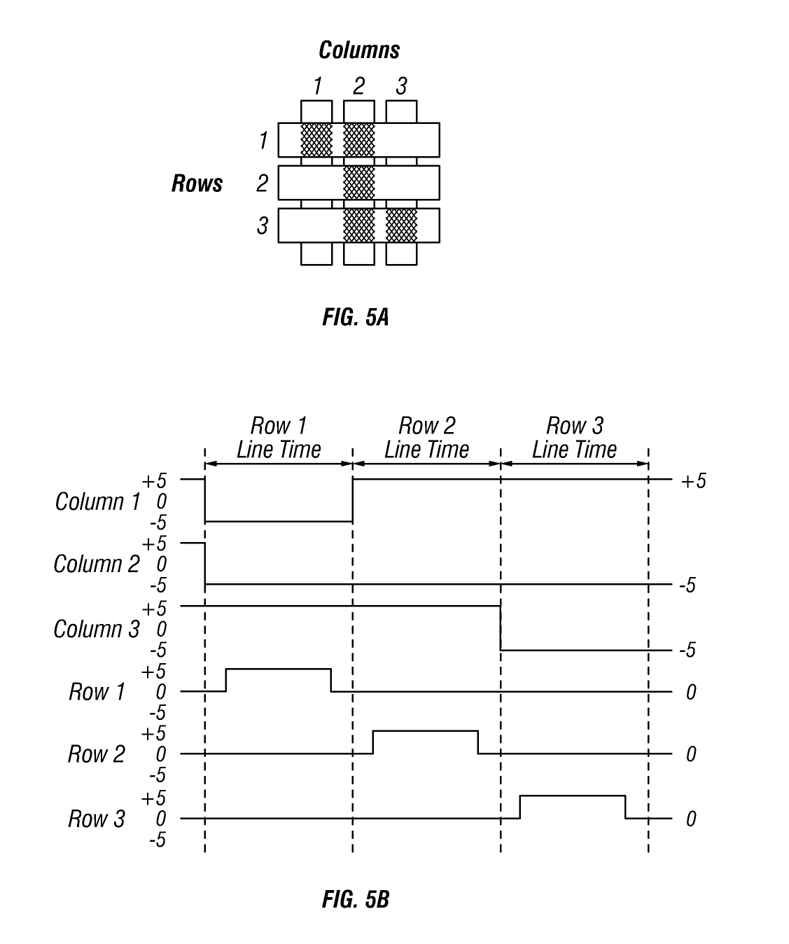

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively. Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

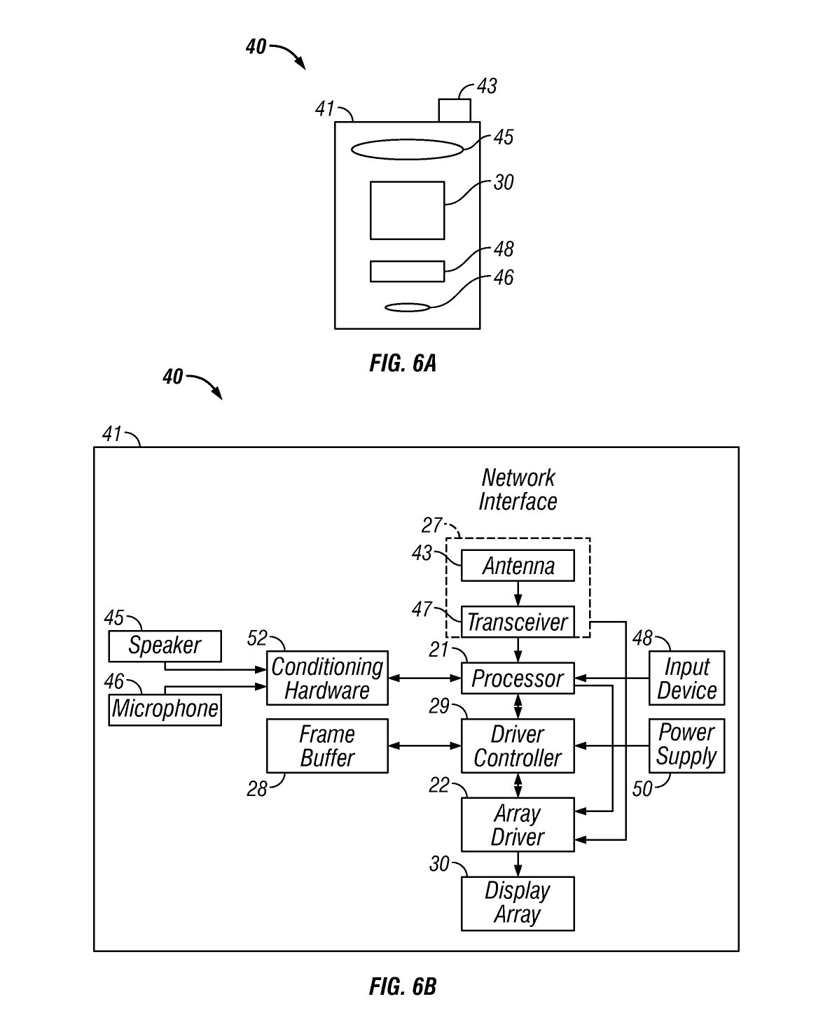

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes as are well known to those of skill in the art, including injection molding, and vacuum forming. In addition, the housing 41 may be made from any of a variety of materials, including but not limited to plastic, metal, glass, rubber, and ceramic, or a combination thereof In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to the processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28 and to the array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. Those of skill in the art will recognize that the above-described optimization may be implemented in any number of hardware and/or software components and in various configurations.

As discussed above, some display elements, such as LCD pixels or interferometric modulators, are specular elements that do not emit light, but rather reflect, transmit, or absorb incident light. In poorly lit conditions, including dark and dim conditions, displays with specular display elements may not be easily viewed. To mitigate this problem, displays can include an illumination system to provide incident light for the display elements.

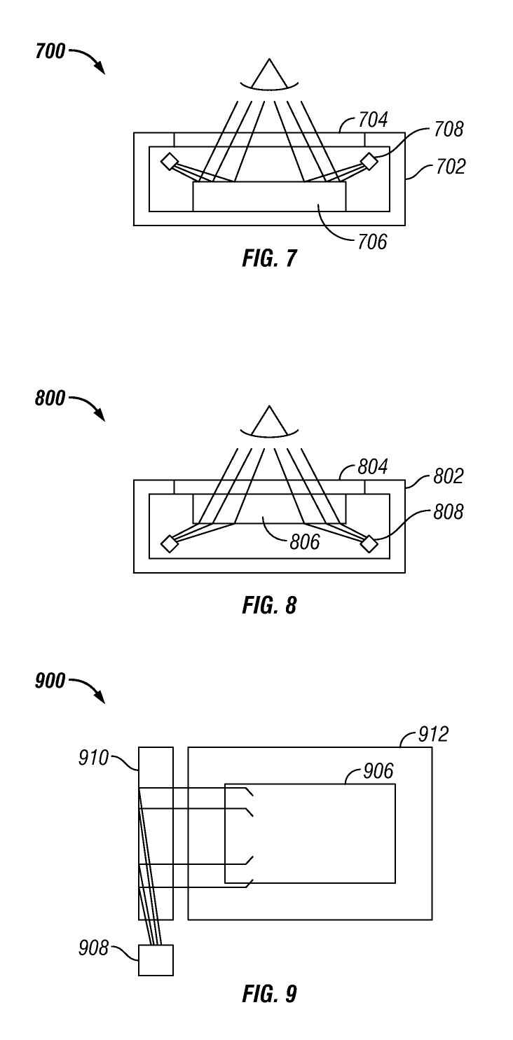

FIG. 7 is a side view of a display 700 including a front light. The display 700 includes a housing 702 that houses an array of display elements 706 and a number of light sources 708 configured to generate light which illuminates the array of display elements 706. The housing 702 can include a transparent shield 704 through which external light can strike the display elements 706 and through which a user can view light reflected by the display elements 702. Exemplary housing materials and manufacturing methods are described above with respect to FIGS. 6A-6B. The transparent shield 704 can be made from any suitably transparent material, including but not limited to glass or plastic. In one embodiment, the shield 704 is made of a scratch-resistant material.

The display elements 706 can include interferometric modulators, LCD pixels, or any other specular display elements. In one embodiment, the display elements 706 are configured to reflect light when in an “on” state and to either transmit or absorb light when in an “off” state. In one embodiment, the display elements 706 transmit light when in an “off” state and an absorption layer (not shown) is placed behind the array of display elements to absorb the transmitted light.

The light sources 708 may be any devices capable of producing light. In one embodiment, the light sources 718 include an LED, such as a multi-colored or phosphor-based white LED. In another embodiment, multiple LEDs are used. For example, in one embodiment, a red LED, a blue LED, and a green LED may be collocated to substantially produce white light. In another embodiment, multiple LEDs are located at various locations around the display elements 706.

In another embodiments, the light sources 708 can include incandescent light bulbs, cold cathode fluorescent lamps, or hot cathode fluorescent lamps. Light from an external source or from the light sources 708 is selectively reflected by the display elements 706 to the eye of the user. In one embodiment, the light sources 708 are controlled by a processor such that they emit light only when a sensor indicates dim or dark conditions or when prompted by a user via an input device.

FIG. 8 is a side view of a display 800 including a back light. The display 800 includes a housing 802 that houses an array of display elements 806 and a number of light sources 808 configured to generate light which illuminates the array of display elements 806. The housing 802 can include a transparent shield 804 through which external light can strike the display elements 806 and through which a user can view light transmitted by the display elements 806. Exemplary housing materials and manufacturing methods are described above with respect to FIGS. 6A-6B. The transparent shield 804 can be made from any suitably transparent material, including but not limited to glass or plastic. In one embodiment, the shield 804 is made of a scratch-resistant material. In one embodiment, the shield 804 is the substrate upon which the display elements 806 are formed.

The display elements 806 can include interferometric modulators, LCD pixels, or any other specular display elements. In one embodiment, the display elements 806 are configured to transmit light when in an “on” state and to either reflect or absorb light when in an “off” state. The light sources 808 may be any devices capable of producing light, including LEDs, incandescent light bulbs, cold cathode fluorescent lamps, hot cathode fluorescent lamps, or an electroluminescent panel. Light from the light sources 808 is selectively transmitted by the display elements 806 to the eye of the user. In one embodiment, the light sources 808 are controlled by a processor such that they are on, i.e. emit light, only when a sensor indicates dim or dark conditions or when prompted by a user via an input device. In another embodiment, when the light sources 808 are on, the display elements transmit light in an “on” state, but when the light sources 808 are off, the display elements reflect light in the “on” state, thereby selectively reflecting light from an external source to the eye of the user.

Some of the potential light sources described above with respect to FIGS. 7 and 8 do not inherently provide a desired uniform illumination of an array of display elements. FIG. 9 is a front view (or back view) of display 900 including an illumination system including a light source 908, a turning bar 910, and a turning film 912. The turning bar 910 and the turning film 912 redirect light emitted from the light source 908 to the array of display elements 906.

In one embodiment, the turning film 912 is positioned over the array of display elements 906 such that light from an external source passes through the turning film 912 while propagating to the array of display elements 906. The display 900 is also configured such that light emitted from the light source 906 is redirected by the turning bar 910 to the turning film 912, where it is further redirected downwards to the display elements 906, where it is selectively reflected to the user. In another embodiment, the turning film 912 is positioned beneath the array of display elements 906 such that light from an external light source impinges on the display elements 908 without passing through the turning film 912. The display 900 is also configured such that light emitted from the light source 906 is redirected by the turning bar 910 to the turning film 912, where it is further redirected upwards to the display elements 906, where it is selectively transmitted to the user. As described above, in another embodiment, when the light source 908 is on, the display 900 is placed into a “transmissive mode” wherein the display elements transmit light in an “on” state, thereby selectively transmitting light from the light source 908 to the eye of the user, but when the light source 908 is off, the display 900 is placed into a “reflective mode” wherein the display elements reflect light in the “on” state, thereby selectively reflecting light from an external source to the eye of the user.

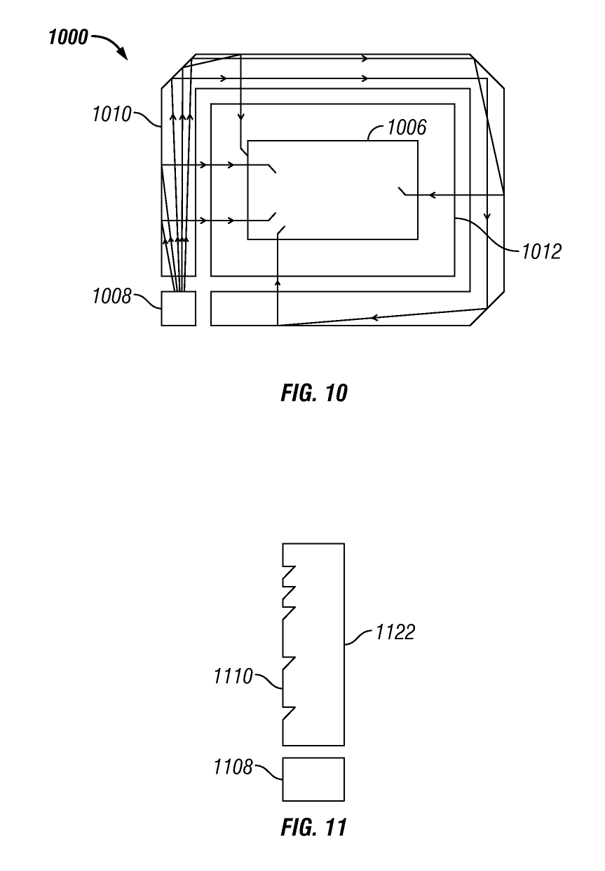

In FIG. 9, the turning bar 910 is shown disposed near the left edge of the turning film 912. However, the turning bar 910 can be placed near any suitable edge of the turning film 912 if the turning film 912 is configured to receive light through that particular film edge and redirect the light to the array of display elements 906. FIG. 10 illustrates another embodiment of a display 1000 having an illumination system including a light source 1008, a turning bar 1010, and a turning film 1012. In the display 1000 illustrated in FIG. 10, the turning bar 1010 includes multiple segments surrounding the turning film 1012. Light from the light source 1008 which passes through one segment is reflected at a mirror along the next segment, until it is redirected towards the turning film 1012 and toward the array of display elements 1006.

FIG. 11 illustrates an embodiment of a turning bar. Various structures can be included in the turning bar to redirect the light to the array of display elements. In one embodiment, the turning bar 1110 is a transparent material, such as glass, which includes protrusions 1120 cut into the turning bar 1110 which act as mirrors. The turning bar 1110 may be designed such that extraction efficiency varies with distance from the light source 1108, such that the intensity of light exiting a surface of the light bar 1122 is uniform across the surface. In another embodiment, the surface 1122 acts as a diffuser, thereby providing a more uniform illumination to the turning film. The protrusions may be formed as parabolic mirrors such that light exiting the surface 1122 is collimated. Similar or different structures can be employed in the turning film.

An electronic device having a display such as those describe above may also benefit from an accelerometer. For example, an accelerometer can be used as an input device to allow a user to control the electronic device by moving it. An accelerometer can be used to detect if the device is dropped which may result in an impact to the device. In response to such detection, the device may automatically save a state of the device or user documents or shut down portions of the device.

Generally, an accelerometer functions to determine acceleration by detecting the motion of a proof mass with respect to another mass. In one embodiment, at least a portion of the illumination system is used as the proof mass. Thus, detection of the motion of at least a portion of the illumination system, such as the light source or a light redirector, can be used to determine an acceleration of the electronic device. Because a separate proof mass is not required, the footprint of the device can be reduced. Further, the cost of the device can also be reduced.

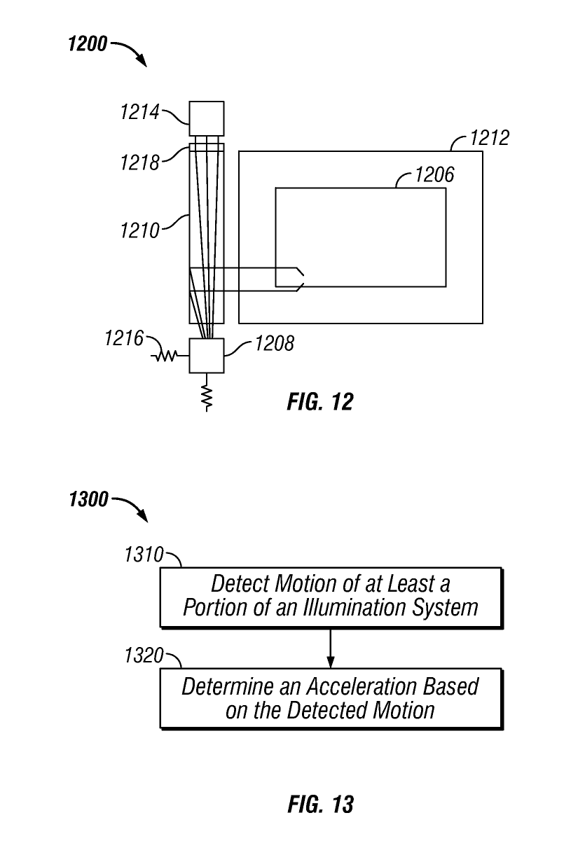

FIG. 12 is a front view (or back view) of a display 1200 having an integrated illumination system and accelerometer. The display 1200, like those described above, includes an array of display elements 1206, which are configured to be at least partially illuminated by an illumination system including a light source 1208, a turning bar 1210, and a turning film 1212. The turning bar 1210 and turning film 1212 fall into the class of light redirectors, which can include mirrors which reflect light and lenses which refract light. The light redirectors can be of glass, plastic, or other reflective or transparent materials. The display 1200 is also configured to function as an accelerometer in that the light source 1208 is movable with respect to a detector 1214 in response to motion of the display 1200.

In one embodiment, the light source 1208 is attached to a housing of the display 1200 via one or more springs 1216. As used herein, a spring is any elastic object which stores mechanical energy. For example, the light source 1208 may be attached to the housing of the display 1200 via a rubber casing. In another embodiment, the light source 1208 is attached to the housing via stiff, yet bendable prongs. In another embodiment, the light source 1208 is attached via one or more coil or helical springs. These and other types of springs can experience and respond differently to linear or angular acceleration. For example, the stiff, bendable prongs may act as both compression and torsional springs.

The detector 1214 can be configured to determine linear or angular accelerations. In another embodiment, the display 1200 includes multiple detectors located at various locations about the display or an array of detectors to detect acceleration in multiple directions, such as the three perpendicular directions of an x-axis, a y-axis, and z-axis or in the six axes including rotational axes.

In other embodiments, other portions of the illumination system are instead or also suspended, such as the turning bar 1210 or turning film 1212. In another embodiment, the detector 1214 or the display elements 1206 may be attached via springs. In a further embodiment, a separate light source, such as an infrared LED is attached via springs. The infrared light source is configured to propagate light through at least a portion of the illumination system to the detectors. In yet another embodiment, the light source (or other illumination system portion) is not coupled the housing, but to another object so long as the light source moves with respect to the detector in response to acceleration.

When the display 1200 is moved or otherwise subjected to acceleration, the light source 1208 moves with respect to the detector 1214. This motion is detected by the detectors and converted into acceleration by a processor. In one embodiment, the detector 1214 detects this relative motion as a change in a characteristic of the light reaching the detector 1214. For example, the detector 1214 may detect this relative motion as a change in light intensity, color, or polarity.

It is desirable that the motion of the light source 1208 with respect to the detector 1214 not substantially interfere with the user's viewing of the device. Thus, in one embodiment, the display 1200 is configured such that the relative movement is detectable by the detector, but undetectable by the human eye, directly or via artifacts when viewing the display elements 1206.

In order to detect minute changes in light characteristic, an amplification element 1218 may be placed optically between the light source 1208 and the detector 1214, wherein optically between means within the path of a light ray emanating from the light source 1208 and striking the detector 1214. In order to minimize the effect of the motion on the illumination of the display elements 1206, the amplification element 1218 may be placed proximal to the detector 1214, such that light that passes through the amplification film 1218 does not reach the display elements 1206. The amplification element 1218 does not necessarily amplify the intensity of light, but is configured to alter the light along the optical path based on the relative motion of the light source 1208 with respect to the detector 1214 so as to amplify a change in light characteristic, such as intensity, color, or polarity. For example, the amplification element 1218 may be configured such that a small change in intensity of light impinging on the amplification element 1218 results in a large change in intensity of light impinging on the detector 1214. The amplification element 1218 can be a mechanical structure or a digital element. In one example, the amplification element 1218 may be substantially opaque except for a slit through which light passes only when the display 1200 is not subject to threshold amount of acceleration in a particular direction. As another example, the amplification element 1218 may be substantially opaque except for a pinhole through which light passes only when the display 1200 is not subject to threshold acceleration in two particular directions. The pinhole may be oblong such that the threshold acceleration is different in the two particular directions. In another embodiment, the opacity of the amplification element 1218 is a radial gradient from transmissive at the center to substantially opaque at the edges such that when the light source 1208 moves with respect to the detector 1208, the intensity of the light is diminished. The amplification element 1218 may refract the light into a rainbow of colors, such that at different accelerations, different wavelengths of light contact the detector 1214.

In another embodiment, the light source 1208 is rigidly attached to the display and the detector 1214 is attached to the display via one of more springs. In this embodiment, the light source 1208, turning bar 1210, turning film 1212, and display elements 1206 are fixed with respect to each other. Accordingly, acceleration and movement does not affect the illumination of the display elements 1206 by the light source 1208. However, the motion of the detector 1214, which is a relative movement between the light source 1208 and the detector 1214 can be detected in the same manner as described above.

FIG. 13 is a flowchart illustrating a method of determining an acceleration. Such a method can be performed by an electronic device including a display such as those described above. The method 1300 begins, in block 1310, with the detection of a movement of at least a portion of an illumination system of the display device. This detection can be performed, for example, by detector 1214 of FIG. 12. For example, the detection of movement may be a measure of changing light intensity or of light wavelength. The method 1300 continues to block 1310 where an acceleration based at least in part on the detected movement is determined. In one embodiment, the determined acceleration can be a value. For example, the acceleration can be determined (and stored in a memory) in g-force units (gs) or in m/s². In another embodiment, the determined acceleration can simply be an indication of the presence of at least a predetermined threshold acceleration in a particular direction. Thus, the acceleration can be stored in a memory as a one-bit flag which is ‘1’ in the presence of the acceleration and a ‘0’ when the acceleration is not present. In one embodiment, a processor determines an acceleration according to a formula for which the detected light characteristic is an input. In another embodiment, the processor determines an acceleration when the light characteristic crosses a predetermined threshold. The determined acceleration may be linear or angular, or include multiple accelerations including linear and/or angular components.

While the above description points out certain novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A display device comprising:
a plurality of display elements;
an illumination system comprising at least a light source and configured to direct light emitted by the light source to the display elements;
a detector configured to detect movement of at least a portion of the illumination system relative to the detector; and
a processor configured to determine one or more accelerations based, at least in part, on the detected movement.

2. The display device of claim 1, wherein the display elements comprise interferometric modulators.

3. The display device of claim 1, wherein the display elements comprise liquid crystal display (LCD) pixels.

4. The display device of claim 1, wherein the light source comprises a light emitting diode (LED).

5. The display device of claim 1, wherein the illumination system directs light through the display elements to a viewer.

6. The display device of claim 5 wherein the processor is configured to drive the display elements to display an image in a transmissive mode when the illumination system is in an on state and in a reflective mode when the illumination system is in an off state.

7. The display device of claim 1, wherein the illumination system directs light towards the display elements from the direction of a viewer.

8. The display device of claim 1, wherein the illumination system further comprises one or more light redirectors.

9. The display device of claim 8, wherein the light redirectors comprise a turning bar.

10. The display device of claim 8, wherein the light redirectors comprise a turning film.

11. The display device of claim 8, wherein the light redirectors comprise a mirror.

12. The display device of claim 1, further comprising an amplification element optically between the light source and the detector configured to amplify a change in light characteristic.

13. The display device of claim 1, wherein the detector is configured to detect movement by determining a light intensity.

14. The display device of claim 1 wherein the detector comprises a plurality of detectors.

15. The display device of claim 1, wherein the processor is configured to determine a horizontal acceleration, a vertical acceleration, and a transversal acceleration.

16. The display device of claim 1, wherein at least a portion of the illumination system is attached to a housing via one or more springs.

17. The display device of claim 1, wherein the detector is attached to a housing via one or more springs.

18. A method of determining an acceleration, the method comprising:
detecting, using a detector, a movement of at least a portion of a illumination system of a display device comprising a plurality of display elements and the illumination system comprising at least a light source and configured to direct light emitted by the light source to the display elements; and
determining, using a processor, an acceleration based, at least in part, on the detected movement.

19. The method of claim 18, wherein the detected movement is undetectable by a human eye.

20. A system for determining an acceleration, the system comprising:
modulation means for modulating light;
illumination means comprising at least a light generation means and for directing light emitted by a light generation means to the display elements the modulation means;
detection means for detecting movement of at least a portion of the illumination means relative to the detection means; and
processing means for determining one or more accelerations based, at least in part, on the detected movement.

21. The system of claim 20, wherein the illumination means further comprising a means for redirecting light.

22. A display device comprising:
a plurality of display elements;
one or more light sources;
one or more light redirectors configured to redirect at least a portion of the light generated by the light sources to at least a portion of the plurality of display elements;
one or more light detectors each configured to determine a light intensity; and
a processor configured to determine one or more accelerations based on the determined light intensity.

23. A method of determining an acceleration in a display device comprising a plurality of display elements and an illumination system configured to illuminate at least a portion of the display elements, the method comprising using at least a portion of the illumination system as the proof mass of an accelerometer.
